(19) United States
(12) Patent Application Publication
(10) Pub. No.: US 2026/0056452 A1
(43) Pub. Date: Feb. 26, 2026

(54) IMAGING DEVICE AND ATTACHMENT METHOD

(71) Applicant: i-PRO Co., Ltd., Tokyo (JP)

(72) Inventors: Hirokazu TASAKA, Tokyo (JP); Kento Tanaka, Tokyo (JP); Hikaru Konishi, Tokyo (JP)

(73) Assignee: i-PRO Co., Ltd., Tokyo (JP)

(21) Appl. No.: 19/267,189

(22) Filed: Jul. 11, 2025

(30) Foreign Application Priority Data
Aug. 22, 2024 (JP) 2024-141447

(51) Int. Cl. G03B 17/56

(52) U.S. Cl. CPC G03B 17/561

(57) ABSTRACT

An imaging device includes a bracket having an attachment surface to be attached on a wall and a first facing surface on a side opposite to the attachment surface, an imaging unit that captures an image of surroundings, and a camera main body having a second facing surface provided at a position outside an imaging range of the imaging unit. The camera main body can switch postures including an imaging posture in which the camera main body is fixed to the bracket with the first facing surface and the second facing surface facing each other to allow the imaging unit to capture an image, and a preparation posture in which the camera main body is temporarily fixed to the bracket with each of the first facing surface and the second facing surface being exposed.

### TECHNICAL FIELD

The present invention relates to an imaging device and an attachment method thereof.

### BACKGROUND ART

Hitherto, there has been known an imaging device that is attached on a wall to monitor the surroundings (Patent Literature 1). An imaging device described in Patent Literature 1 can monitor the surroundings by fixing a camera main body to a base portion fixed on a wall.

### CITATION LIST

### Patent Literature

Patent Literature 1: JP 7007315 A

### SUMMARY OF INVENTION

### Technical Problem

However, the imaging device in Patent Literature 1 requires a connection operation for electrically connecting a cable extending from the base portion and the camera main body to each other before fixing the camera main body to the base portion. The connection operation is performed while the camera main body is in an unfixed state. Thus, it is necessary to use one hand to hold the camera main body while using the other hand to perform the operation, or a plurality of workers are required. As a result, there is a problem that the connection operation is complicated.

The present invention has been made in view of the above-mentioned circumstance, and has an object to provide an imaging device that can facilitate a connection operation for electrically connecting a bracket and a camera main body to each other.

### Solution to Problem

In order to solve the above-mentioned problem, an imaging device according to the present invention includes a bracket having an attachment surface to be attached on a wall and a first facing surface on a side opposite to the attachment surface, an imaging unit that captures an image of surroundings, and a camera main body having a second facing surface provided at a position outside an imaging range of the imaging unit. The camera main body can switch postures including an imaging posture in which the camera main body is fixed to the bracket with the first facing surface and the second facing surface facing each other to allow the imaging unit to capture an image, and a preparation posture in which the camera main body is temporarily fixed to the bracket with each of the first facing surface and the second facing surface being exposed. The camera main body in the preparation posture is temporarily fixed to the bracket by a wire coupling the first facing surface and the second facing surface to each other, and a locking member being attached to the first facing surface and locking an outer peripheral wall surrounding the second facing surface so that rotation of the camera main body about a first axis parallel to and horizontal with the wall is regulated.

### Advantageous Effects of Invention

According to the present invention, it is possible to obtain an imaging device that can facilitate a connection operation for electrically connecting a bracket and a camera main body to each other. Note that problems, configurations, and effects other than those described above are clarified by the description of embodiments below.

### BRIEF DESCRIPTION OF DRAWINGS

FIG. 1 is a perspective view of a surveillance camera when a camera main body is in an imaging posture.

FIG. 2 is an exploded perspective view of the surveillance camera.

FIG. 3 is a perspective view of the surveillance camera when the camera main body is a preparation posture.

FIG. 4 is a cross-sectional view of a bracket and a base portion in a direction orthogonal to an X direction (a cross-sectional view taken along the line IV-IV in FIG. 3).

FIG. 5 is a flowchart illustrating an assembly method of a surveillance camera.

FIG. 6 is a perspective view of a locking member.

FIG. 7 is a three-view diagram of the locking member.

FIG. 8 is a diagram of the locking member and an outer peripheral wall as viewed along the X direction.

FIG. 9 is a diagram of the locking member entering a cutout as viewed along a Z direction.

FIG. 10 is a cross-sectional view of the locking member and the outer peripheral wall in a direction that passes through an opening and is orthogonal to a Y direction (a cross-sectional view taken along the line X-X in FIG. 9).

### DESCRIPTION OF EMBODIMENTS

Hereinafter, an embodiment of the invention is described with reference to the drawings. The embodiment contributes to “9. Basis of Industry and Technical Innovation” of Sustainable Development Goals (SDGs) proposed by UN by realizing a surveillance camera 1 that is highly versatile.

### Overall Configuration of Surveillance Camera 1

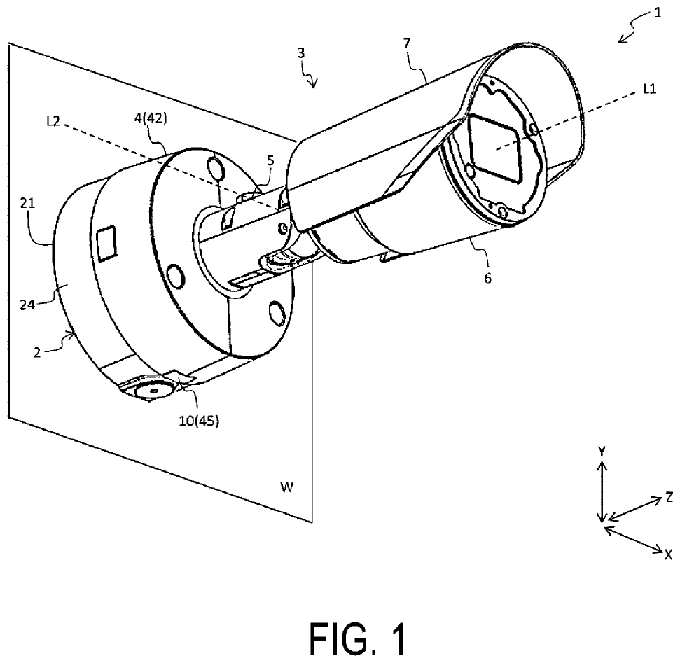

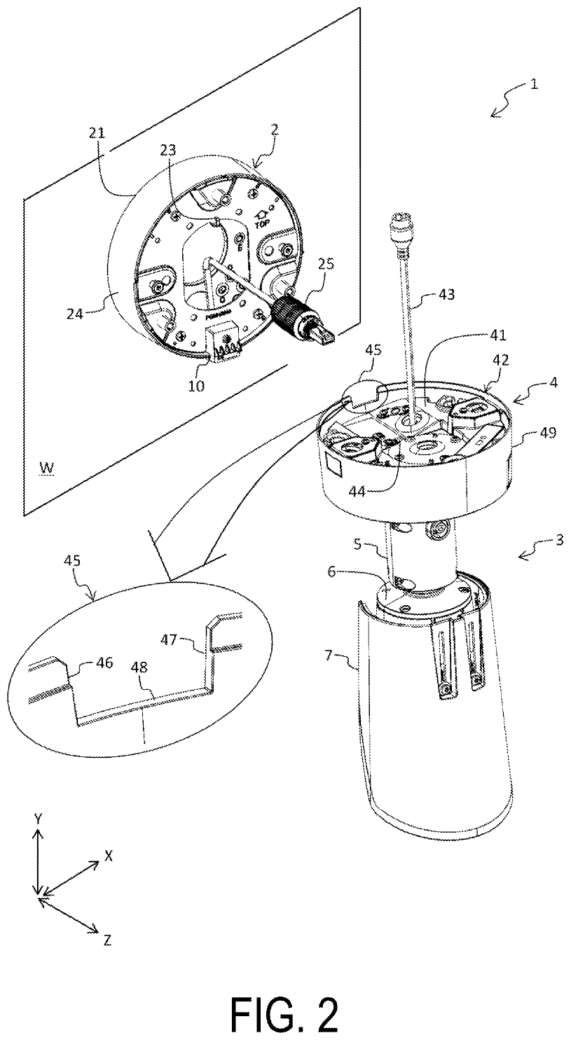

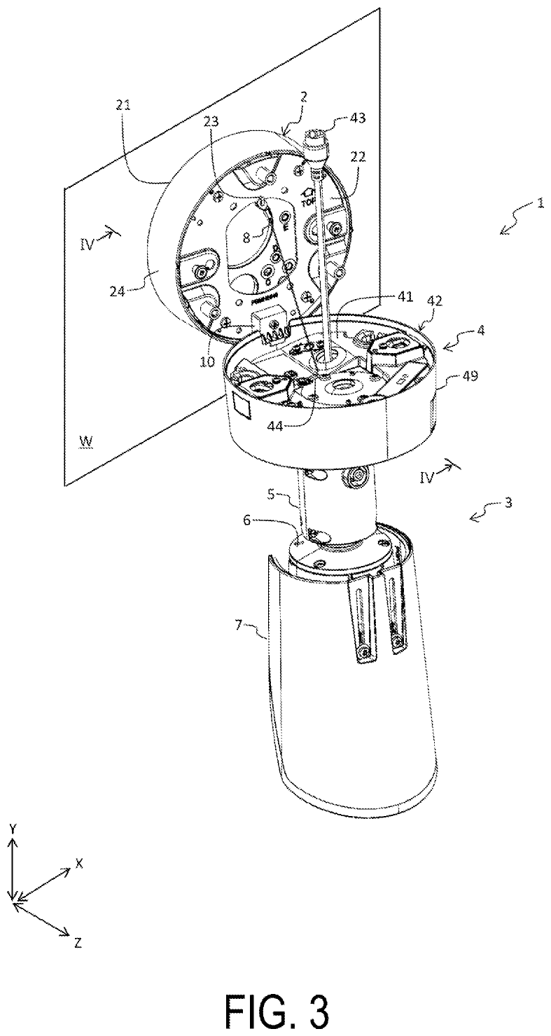

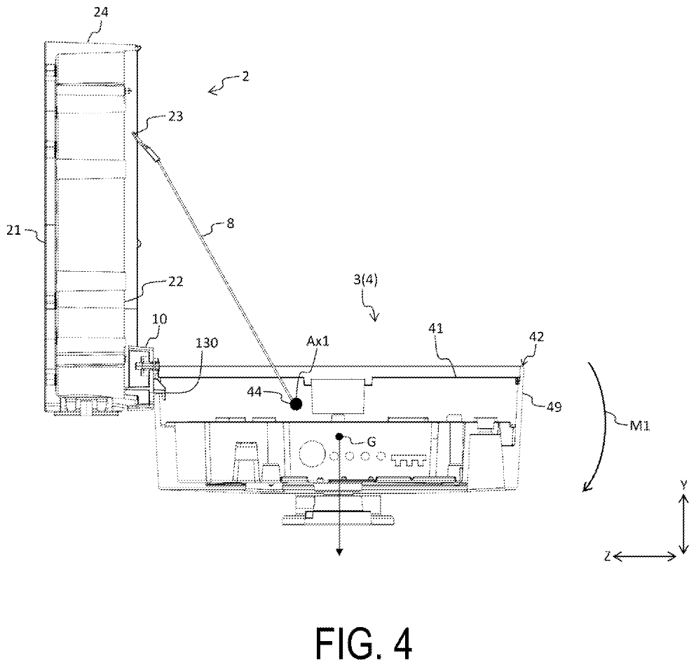

FIG. 1 is a perspective view of the surveillance camera 1 when a camera main body 3 is in an imaging posture. FIG. 2 is an exploded perspective view of the surveillance camera 1. FIG. 3 is a perspective view of the surveillance camera 1 when the camera main body 3 is in a preparation posture. FIG. 4 is a cross-sectional view of a bracket 2 and a base portion 4 in a direction orthogonal to an X direction (a cross-sectional view taken along the line IV-IV in FIG. 3). The surveillance camera 1 is an imaging device that is installed on a wall W to monitor the surroundings. More specifically, the surveillance camera 1 captures an image of an object in the surroundings, and outputs an image signal (for example, a still image signal or a moving image signal). As illustrated in FIG. 1, the surveillance camera 1 mainly includes the bracket 2 and the camera main body 3.

The wall W is erected in a substantially vertical manner. However, the wall W may be inclined with respect to the vertical direction. Further, the front surface of the wall W is a substantially flat surface. In the following description, among directions parallel to the wall W, a horizontal direction is defined as the “X direction”, the vertical direction is defined as a “Y direction”, and a direction vertical to the front surface of the wall W is defined as a “Z direction”. In other words, the X direction, the Y direction, and the Z direction are directions orthogonal to one another.

The bracket 2 is a member that is attached on the wall w and supports the camera main body 3.

The bracket 2 has a substantially disk-like outer shape. Further, of both the end surfaces of the disk-like bracket 2, a surface to be attached on the wall W is an attachment surface 21, and a surface on a side opposite to the attachment surface 21 is a first facing surface 22. Note that each of the attachment surface 21 and the first facing surface 22 is not limited to a single surface, and may be configured by a plurality of surfaces (in other words, irregularities are formed). The same applies to other surfaces described below (for example, a second facing surface 41, an outer surface 49 of an outer peripheral wall 42, and a front surface 113 of a main wall 111).

The attachment surface 21 is a surface to be attached on the wall W. The first facing surface 22 is a surface facing the second facing surface 41, which is described below, when the camera main body 3 is in the imaging posture illustrated in FIG. 1. Further, the first facing surface 22 is exposed to the outside when the camera main body 3 is in the preparation posture illustrated in FIG. 3.

Further, the first facing surface 22 is a surface on which a locking member 10 described below is removably attached.

Moreover, the first facing surface 22 is provided with a locking portion 23 to which the other end of a wire 8, which is described below, is removably locked.

Moreover, the bracket 2 includes an outer peripheral wall 24. The outer peripheral wall 24 is continuous in the circumferential direction so as to surround the attachment surface 21 and the first facing surface 22. Further, the outer peripheral wall 24 projects in the Z direction from the first facing surface 22 so as to be away from the attachment surface 21. Moreover, the outer surface of the outer peripheral wall 24 is a surface exposed to the outside when the camera main body 3 is in the imaging posture and the preparation posture.

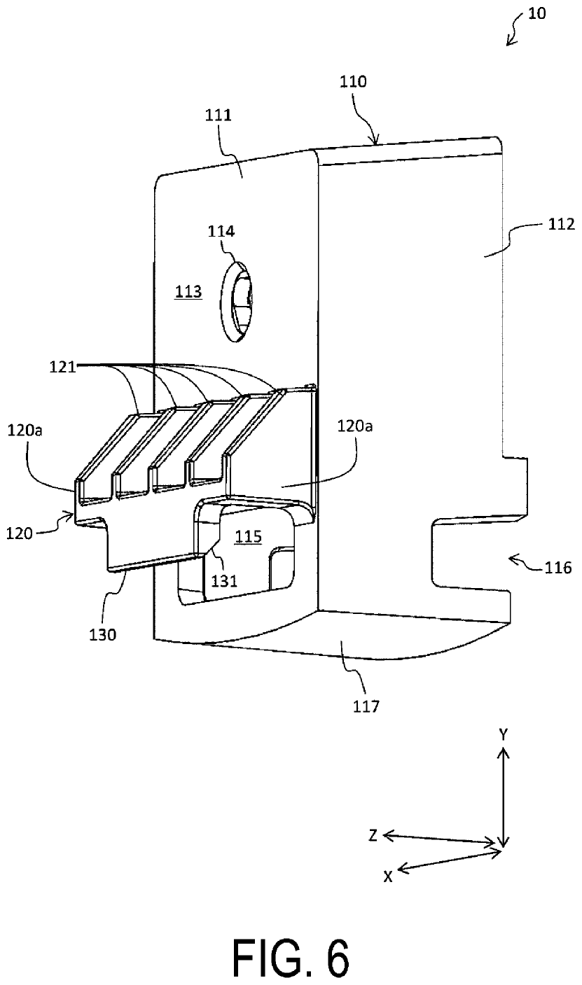

The locking member 10 is a member that locks the camera main body 3 in the preparation posture to the bracket 2. The locking member 10 is attached to the first facing surface 22. Further, a part of the locking member 10 (more specifically, a part of a lower surface 117 side with respect to a slit 116) is positioned outside the outer peripheral wall 24 of the bracket 2. Further, as illustrated in FIG. 2, the locking member 10 is positioned at a lower end of the bracket 2 attached on the wall W. Moreover, the locking member 10 is removably attached to the bracket 2. A specific method of attaching the locking member 10 to the attachment surface 21 is not particularly limited, but fixation with a bolt may be conceived, for example. The details of the locking member 10 are described with reference to FIGS. 6 to 10.

Inside the bracket 2, a space through which a cable 25 passes is formed. Further, the bracket 2 causes the cable 25 to extend. More specifically, the bracket 2 causes the cable 25, which is routed inside or along the front surface of the wall W, to extend from the first facing surface 22. Note that, in FIG. 3, the cable 25 is omitted in illustration. In another example, a control substrate may be accommodated inside the bracket 2. Further, the cable 25 including one end connected to the control substrate may extend from the first facing surface 22. A specific function of the cable 25 is not particularly limited, and the cable 25 may be a power source cable, a communication cable (LAN cable), or the like.

The camera main body 3 is fixed to the bracket 2, and captures an image of the surroundings. Further, the camera main body 3 is configured to be attachable and removable with respect to the bracket 2. The camera main body 3 mainly includes the base portion 4, an arm 5, an imaging unit 6, and a shade 7.

The base portion 4 is a portion that is fixed to the bracket 2. The base portion 4 has a substantially disk-like outer shape. An end surface of the disk-like base portion 4 on one side serves as the second facing surface 41.

Further, the arm 5 extends from an end surface of the disk-like base portion 4 on the other side. Moreover, the outer periphery of the disk-like base portion 4 serves as the outer peripheral wall 42.

The second facing surface 41 is a surface provided at a position outside an imaging range of the imaging unit 6.

More specifically, the second facing surface 41 is a surface of the disk-like base portion 4 on a side opposite to the surface from which the arm 5 extends. Further, the second facing surface 41 is a surface that faces the first facing surface 22 when the camera main body 3 is in the imaging posture. Moreover, the second facing surface 41 is a surface that is exposed to the outside when the camera main body 3 is in the preparation posture. Further, the camera main body 3 includes a cable 43 including one end connected to the imaging unit 6 and the other end extending from the second facing surface 41.

Moreover, the second facing surface 41 is provided with an attachment portion 44 to which one end of the wire 8 is attached. As illustrated in FIG. 4, the attachment portion 44 is provided at a position closer to the bracket 2 (in other words, a cutout described below) with respect to the gravity center position G of the camera main body 3 when the camera main body 3 is in the preparation posture. For example, the gravity center position G is positioned at the center of the disk-like base portion 4. The wire 8 is an elongated string-like member having flexibility. Further, the wire 8 couples the first facing surface 22 and the second facing surface 41 to each other when the camera main body 3 is in the preparation posture. In contrast, when the camera main body 3 is in the imaging posture, the wire 8 may be accommodated between the first facing surface 22 and the second facing surface 41, or may be removed from the attachment portion 44.

The outer peripheral wall 42 is continuous in the circumferential direction so as to surround the second facing surface 41. Further, the tip end of the outer peripheral wall 42 projects to the bracket 2 side (on a side opposite to the imaging unit 6) with respect to the second facing surface 41 when the camera main body 3 is in the imaging posture. Moreover, the outer surface 49 of the outer peripheral wall 42 according to the embodiment has an arc-like shape. However, the shape of the outer surface 49 of the outer peripheral wall 42 is not limited to the example described above.

In the outer peripheral wall 42, a cutout 45 is formed. The cutout 45 is a portion at one position of the outer peripheral wall 42 in the circumferential direction, the portion being recessed from the tip end of the outer peripheral wall 42 toward the second facing surface 41.

More specifically, the cutout 45 is provided at a position closest to the bracket 2 when the camera main body 3 is in the preparation posture. Further, the cutout 45 is closed by the locking member 10 attached to the bracket 2 when the camera main body 3 is in the imaging posture.

More specifically, when the lower surface 117 of the locking member 10 is accommodated in the cutout 45, the space of the cutout 45 can be filled.

The cutout 45 is a space surrounded by a pair of vertical sides 46 and 47, and a depth side 48. The size and the shape of the cutout 45 are set to be the same as those of the lower surface 117 of the locking member 10. The pair of vertical sides 46 and 47 are arranged to be spaced apart from each other in the circumferential direction of the outer peripheral wall 42. Further, the pair of vertical sides 46 and 47 are provided to extend in parallel to each other along a projection direction of the outer peripheral wall 42. The depth side 48 connects deep ends of the pair of vertical sides 46 and 47 (ends on a side opposite to the tip end of the outer peripheral wall 42) to each other.

Further, the depth side 48 is provided to extend along the circumferential direction of the outer peripheral wall 42.

The arm 5 has a substantially columnar outer shape. The arm 5 connects the base portion 4 and the imaging unit 6 to each other. More specifically, of both ends of the columnar arm 5 in the axial direction, one end is connected to an end surface of the base portion 4, which is on a side opposite to the second facing surface, and the other end is connected to the imaging unit 6. Moreover, inside the arm 5, a space through which the cable 43 provided to extend from the camera main body 3 toward the base portion 4 passes is provided.

The imaging unit 6 is a unit that captures an image of the surroundings. The imaging unit 6 is obtained by integrating (unitizing) an image sensor, a lens that collects external light and causes the light to enter the image sensor, and the like. The image sensor is, for example, a complementary metal-oxide-semiconductor (CMOS) or a charge-coupled device (CCD).

The shade 7 is a portion that covers the imaging unit 6. The shade 7 adjusts an amount of external light entering the lens of the imaging unit 6. For example, the shade 7 moves forward and backward (advances and retracts) along the extension direction of the arm 5.

When the camera main body 3 is in the imaging posture illustrated in FIG. 1, the arm 5 and the imaging unit 6 are configured to be rotatable about a rotation axis L1 with respect to the base portion 4. Further, the imaging unit 6 is configured to be rotatable about the rotation axis L1 with respect to the arm 5. Moreover, the imaging unit 6 is configured to be rotatable about a rotation axis L2 with respect to the arm 5. The rotation axis L1 passes through the centers of the arm 5 and the imaging unit 6, and is provided to extend in the Z direction when the camera main body 3 is in the imaging posture. The rotation axis L2 passes through the tip end of the arm 5, and is provided to extend in the X direction when the camera main body 3 is in the imaging posture.

The camera main body 3 can switch postures including the imaging posture illustrated in FIG. 1 and the preparation posture illustrated in FIG. 3. The imaging posture is a posture of the camera main body 3 fixed to the bracket 2 with the first facing surface 22 and the second facing surface 41 facing each other. Further, the imaging posture is a posture of the camera main body 3 allowing the imaging unit 6 to capture an image. The preparation posture is a posture of the camera main body 3 temporarily fixed to the bracket 2 with each of the first facing surface 22 and the second facing surface 41 being exposed. Further, the preparation posture is a posture of the camera main body 3 in order to carry out preparation (for example, a connection operation of the cables 25 and 43) for allowing the imaging unit 6 to capture an image. “Temporal fixation” refers to a state in which the bracket 2 and the camera main body 3 are coupled by the cable 43 and the camera main body 3 is locked by the locking member 10. Further, “temporal fixation” refers to temporal fixation of the bracket 2 and the camera main body 3 to connect the cables 25 and 43.

### Assembly Method of Surveillance Camera 1

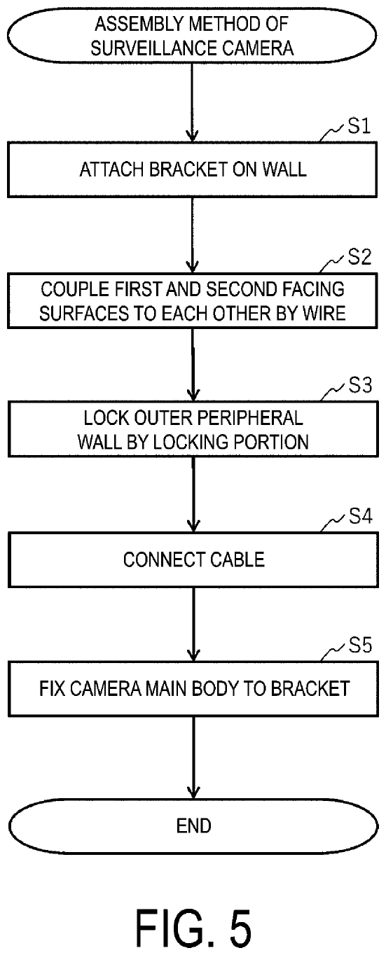

FIG. 5 is a flowchart illustrating an assembly method of the surveillance camera 1. With reference to FIGS. 1 to 5, the assembly method of the surveillance camera 1 (the procedure to install the surveillance camera 1 on the wall W) is described. The operation illustrated in FIG. 5 can be performed by one operator.

First, as illustrated in FIG. 2, an operator attaches the bracket 2 to a predetermined position on the wall W (S1). More specifically, an operator attaches the bracket 2 on the wall W with the attachment surface 21 facing the wall W and the locking member 10 being positioned at the lower end of the bracket 2. A specific method of attaching the bracket 2 is not particularly limited, but fixation with a bolt may be conceived, for example. Step S1 is an example of an attachment step.

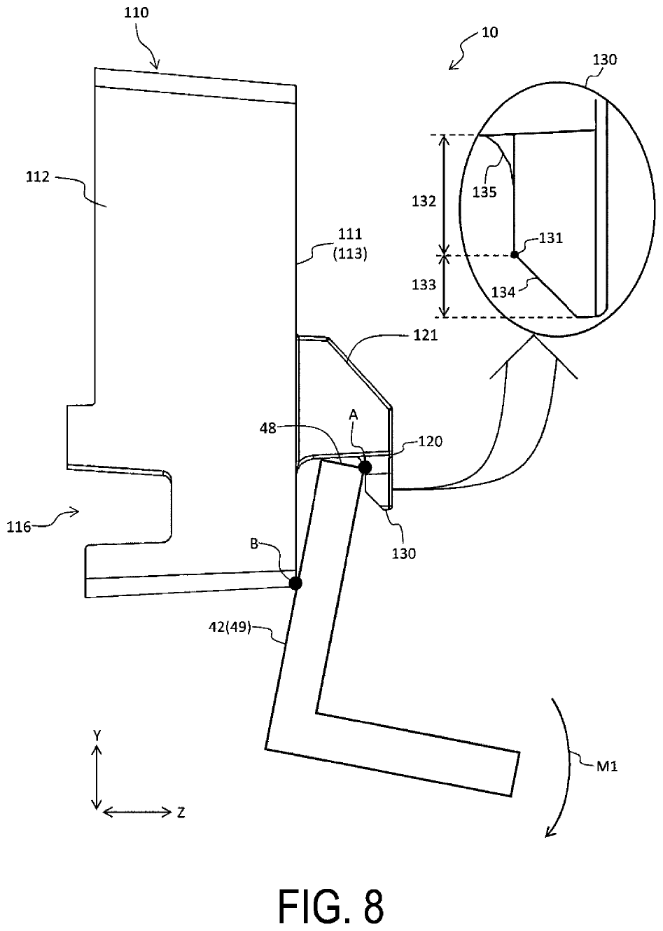

Next, as illustrated in FIG. 3, an operator locks, to the locking portion 23, the other end of the wire 8 whose one end is attached to the attachment portion 44, and thus couples the first facing surface 22 and the second facing surface 41 to each other by the wire 8 (S2). Further, an operator locks the depth side 48 of the outer peripheral wall 42 to the locking member 10 (S3). In Step S3, the locking member 10 enters the cutout 45, and abuts against the depth side 48. In other words, the depth side 48 is arranged between a main body 110 and a claw 130. With this, the camera main body 3 is temporarily fixed to the bracket 2, and is in the preparation posture. Steps S2 and S3 are examples of a temporal fixation step. The positional relationship between the locking member 10 and the outer peripheral wall 42 when the camera main body 3 is in the preparation posture is described below with reference to FIGS. 8 to 10.

Subsequently, an operator connects the cable 43 to the cable 25 extending from the bracket 2 (S4). In this state, the camera main body 3 is temporarily fixed to the bracket 2. Thus, an operator is not required to continue holding the camera main body 3, and can perform the connection operation of the cable 43 by both hands. Step S4 is an example of a connection step.

Subsequently, as illustrated in FIG. 1, an operator cancels locking of the camera main body 3 by the locking member 10, causes the first facing surface 22 and the second facing surface 41 to face each other, and fixes the camera main body 3 to the bracket 2 (S5). With this, the camera main body 3 is fixed to the bracket 2, and is in the imaging posture.

A specific method of fixing the camera main body 3 to the bracket 2 is not particularly limited, but fixation with a bolt may be conceived, for example. Further, an operator causes the locking member 10 to match with the position of the cutout 45, and fixes the camera main body 3 to the bracket 2. With this, the cutout 45 is closed by the locking member 10. Step S5 is an example of a fixation step.

### Configuration of Locking Member 10

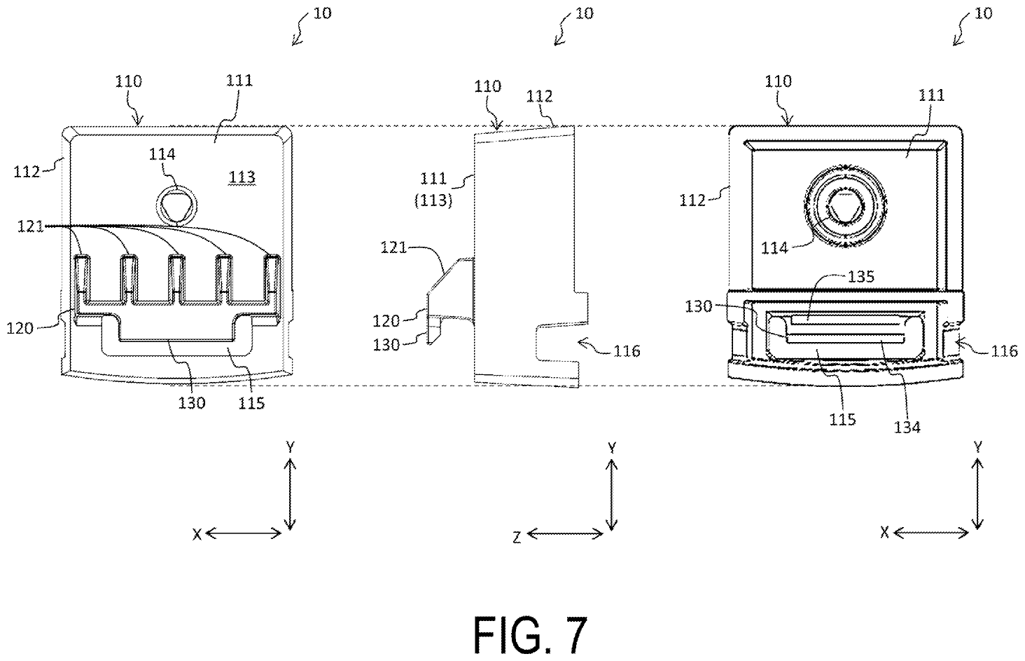

FIG. 6 is a perspective view of the locking member 10. FIG. 7 is a three-view diagram of the locking member 10. Note that, in FIGS. 6 and 7, the X direction, the Y direction, and the Z direction are illustrated while assuming that the bracket 2 is attached on the wall W. As illustrated in FIGS. 6 and 7, the locking member 10 mainly includes the main body 110, a protruding portion 120, and the claw 130. For example, the locking member 10 is integrally molded through injection molding of a resin material.

The main body 110 has a substantially rectangular parallelepiped outer shape. The main body 110 is a portion to be attached to the first facing surface 22 of the bracket 2. The main body 110 is configured by the rectangular main wall 111 orthogonal to the Z direction and a side wall 112 that projects in the Z direction from the outer edge of the main wall 111 toward the bracket 2 and is continuous in the circumferential direction so as to surround the main wall 111. Herein, in the Z direction, a surface of the main wall 111, which faces the bracket 2, is referred to as a back surface, and a surface of the main wall 111, which is on a side opposite to the back surface, is referred to as a front surface 113. Further, in the Z direction, a direction from the main wall 111 toward the bracket 2 is referred to as an inner side in the Z direction. A direction opposite to the inner side in the Z direction, in other words, a direction from the main wall 111 toward the external space in the Z direction is referred to as an outer side in the Z direction. Further, in the Y direction, a direction toward the ground is referred to as a lower side, and a side opposite thereto is referred to as an upper side. Further, the front surface 113 of the main body 110 is provided with the protruding portion 120 extending outward in the Z direction and the claw 130 extending downward from the protruding portion 120.

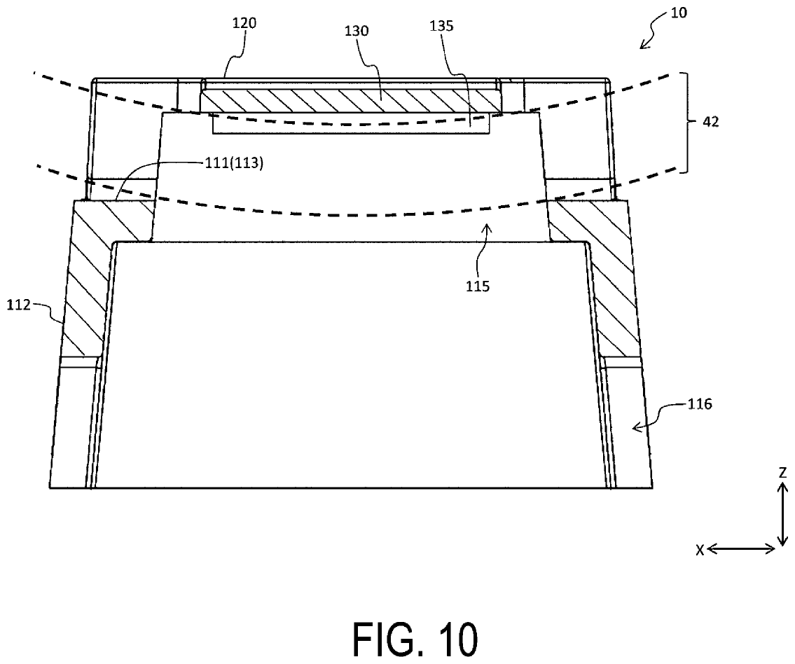

In the main wall 111, a bolt hole 114 and an opening 115 are formed. The bolt hole 114 penetrates the main wall 111 in the Z direction at a position not overlapping with the protruding portion 120 and the claw 130 as viewed along the Z direction. Further, a bolt for fixing the locking member 10 to the first facing surface 22 is inserted into the bolt hole 114. The opening 115 penetrates the main wall 111 in the Z direction at a position not overlapping with the claw 130 as viewed along the Z direction. In other words, the opening 115 is provided at a position facing the inner surface of the claw 130 in the Z direction. In other words, the widths of the opening 115 in the X direction and the Y direction are wider than the widths of the claw 130 in the X direction and the Y direction as viewed along the Z direction. Further, in other words, the opening 115 is provided in a range covering the entire claw 130 as viewed along the Z direction. Further, as described below with reference to FIG. 10, for example, the opening 115 is provided so that the outer peripheral wall 42 abuts against two positions on the front surface 113 of the main wall 111.

The side wall 112 is provided with the slit 116 extending outward in the Z direction toward the main wall 111. The slit 116 is a portion that receives the tip end of the outer peripheral wall 24 of the bracket 2 when the locking member 10 is attached to the bracket 2. Further, the end portion of the side wall 112 on the inner side in the Z direction abuts against the first facing surface 22 when the locking member 10 is attached to the bracket 2. Meanwhile, a surface of the side wall 112 of the locking member 10, which is oriented downward when the bracket 2 is attached on the wall W, is referred to as the lower surface 117. The lower surface 117 is positioned on the outer side of the outer peripheral wall 24 when the locking member 10 is attached to the bracket 2. Further, the lower surface 117 is set to have the same curvature as that of the outer surface 49 of the outer peripheral wall 42 of the base portion 4. Further, the lower surface 117 closes the cutout 45 when the camera main body 3 is attached to the bracket 2.

The protruding portion 120 is provided between the bolt hole 114 and the opening 115 in the Y direction. Further, the protruding portion 120 protrudes from the front surface 113 of the main wall 111 to the outside in the Z direction, and is provided to extend in the X direction. Moreover, a plurality of reinforcement ribs 121 are provided between the main wall 111 and the protruding portion 120. The reinforcement rib 121 connects the front surface 113 of the main wall 111 and the surface of the protruding portion 120, which is on a side opposite to the claw 130, to each other. Further, the reinforcement rib 121 is a wall orthogonal to the X direction. Moreover, the plurality of reinforcement ribs 121 are provided at a plurality of positions spaced apart from each other in the X direction. The reinforcement rib 121 reinforces the claw 130 that locks the camera main body 3.

The claw 130 extends downward in the Y direction from the tip end of the protruding portion 120. Further, the claw 130 is provided to extend in the X direction. However, the width of the claw 130 in the X direction is less than the interval between the pair of vertical sides 46 and 47. Further, the length of the claw 130 in the X direction is less than the length of the protruding portion 120 in the X direction. Moreover, the claw 130 is provided at an interval from the front surface 113 of the main wall 111 in the Z direction. However, the interval between the main body 110 (the main wall 111) and the claw 130 in the Z direction is more than the thickness of the outer peripheral wall 42 in the radial direction. With this, the locking member 10 can enter the cutout 45. In other words, the depth side 48 can enter a space between the main body 110 and the claw 130.

The claw 130 extends downward in the Y direction along the front surface 113. Further, the claw 130 is divided into a base end portion 132 and a tip end portion 133 across an intermediate point 131 in the Y direction. The base end portion 132 is a portion closer to the protruding portion 120 with respect to the intermediate point 131 of the claw 130. The tip end portion 133 is a portion farther from the protruding portion 120 with respect to the intermediate point 131 of the claw 130. The intermediate point 131 is not limited to the middle point (the position equidistant from both the ends) of the claw 130 in the Y direction, and merely indicates the boundary position between the base end portion 132 and the tip end portion 133.

The thickness dimension of the base end portion 132 in the Z direction is constant over the entire region in the Y direction. In contrast, the thickness dimension of the tip end portion 133 in the Z direction is gradually reduced as approaching the lower side in the Y direction (in other words, the tip end of the claw 130). In other words, the tip end portion 133 of the claw 130 has a tapered shape. More specifically, a surface of the tip end portion 133 of the claw 130, which faces the front surface 113 of the main body 110, is provided with an inclination surface 134. The inclination surface 134 is inclined in a direction away from the main body 110 toward the tip end of the claw 130. Further, the inclination surface 134 serves as a guide surface that guides the outer peripheral wall 42 (more specifically, the depth side 48) to enter a space between the main body 110 and the claw 130.

Moreover, a stress alleviation portion 135 is provided between the protruding portion 120 and the claw 130. The stress alleviation portion 135 is provided to a corner portion between the protruding portion 120 and the claw 130 intersecting at a right angle. Further, the stress alleviation portion 135 has an arc-like outer surface. Moreover, the stress alleviation portion 135 is provided to extend in the X direction. Further, the stress alleviation portion 135 includes a function of alleviating a stress concentrated at the corner portion between the protruding portion 120 and the claw 130 when the camera main body 3 is temporarily fixed to the bracket 2.

### Positional Relationship between Locking Member 10 and Outer Peripheral Wall 42

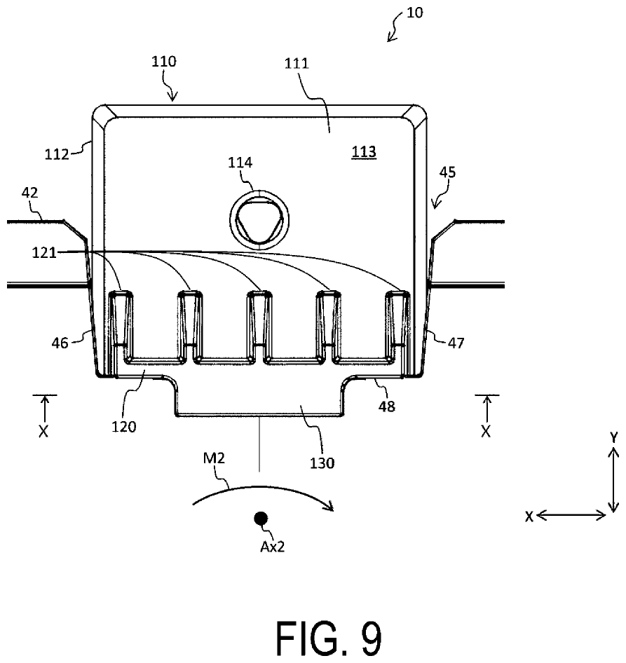

FIG. 8 is a view of the locking member 10 and the outer peripheral wall 42 as viewed along the X direction. FIG. 9 is a diagram of the locking member 10 entering the cutout 45 as viewed along the Z direction. FIG. 10 is a cross-sectional view of the locking member 10 and the outer peripheral wall 42 in the direction that passes through the opening 115 and is orthogonal to the Y direction (a cross-sectional view taken along the line X-X in FIG. 9). With reference to FIGS. 8 to 10, the positional relationship between the locking member 10 and the outer peripheral wall 42 when the camera main body 3 is locked to the bracket 2 is described.

First, as illustrated in FIG. 4, a moment M1 about a first axis Ax1 acts on the camera main body 3 due to the gravitational force acting on the gravity center position G, which is located farther from the bracket 2 with respect to the attachment portion 44. The first axis Ax1 indicates a horizontal linear line parallel to the wall W. The horizontal linear line parallel to the wall W is a linear line passing through the attachment portion 44 and extending in the X direction. In contrast, as illustrated in FIG. 8, the tip end of the depth side 48 of the outer peripheral wall 42 abuts against a surface (position A) of the claw 130 facing the main body 110.

Further, the outer surface 49 of the outer peripheral wall 42 abuts against the front surface 113 (position B) of the main body 110. More specifically, a portion of the outer surface 49 of the outer peripheral wall 42, which is on the lower side with respect to the depth side 48 in the Y direction, and an end portion of the front surface 113, which is on the lower side with respect to the opening 115 in the Y direction, abut against each other. Note that, a surface of the outer peripheral wall 42, which faces the front surface 113, is referred to as the outer surface 49. In this manner, the locking member 10 locks the outer peripheral wall 42 at the positions A and B, and thus regulates rotation of the camera main body 3, which is in the preparation posture, about the first axis Ax1 due to the moment M1.

Further, during the connection operation (S4), when a hand or a body of an operator hits the base portion 4, a moment M2 about a second axis Ax2 acts on the camera main body 3 as illustrated in FIG. 9. The second axis Ax2 indicates a linear line orthogonal to the wall W. The linear line orthogonal to the wall W is a linear line passing through the attachment portion 44 and extending in the Z direction. Further, when the camera main body 3 is about to rotate by the moment M2, the pair of vertical sides 46 and 47 abut against the protruding portion 120. More specifically, the pair of vertical sides 46 and 47 abut against side surfaces 120a of the protruding portion 120. With this, the locking member 10 regulates rotation of the camera main body 3, which is in the preparation posture, about the second axis Ax2.

Moreover, as illustrated in FIG. 10, a part of the outer surface 49 of the outer peripheral wall 42 that enters the space between the main body 110 and the claw 130 can enter the opening 115. Thus, the outer peripheral wall 42 can easily enter the space between the main body 110 and the claw 130. Further, the outer surface 49 of the outer peripheral wall 42 can abut against the main body 110 (more specifically, the main wall 111) at the two positions across the opening 115 in the X direction. With this, as compared to a case in which the outer peripheral wall 42 abuts against the main body 110 at one position, the camera main body 3 is stably locked.

### Advantageous Effects of Embodiment

According to the embodiment described above, the camera main body 3 in the preparation posture is temporarily fixed to the bracket 2 by the wire 8 and the locking member 10, and thus an operator can perform the connection operation (S3) by both hands. With this, the connection operation can be facilitated.

Further, according to the embodiment described above, the attachment portion 44 is provided at the position closer to the bracket 2 with respect to the gravity center position G. With this, the camera main body 3 can be locked to the locking member 10 against the moment M1. With this, the camera main body 3 in the preparation posture can be stably locked to the bracket 2. As a result, the connection operation can be facilitated.

Further, according to the embodiment described above, the locking member 10 enters the cutout 45 formed at one position of the outer peripheral wall 42 in the circumferential direction. With this, the camera main body 3 can be temporarily fixed to the bracket 2 at the right position in the circumferential direction. With this, twisting of the cable 43 can be prevented when the camera main body 3 is in the imaging posture. In other words, the cutout 45 is used to position the camera main body 3 with respect to the bracket 2 in the circumferential direction. However, in view of locking the camera main body 3 to the bracket 2, the cutout 45 may be omitted. Further, in place of the cutout 45, a mark formed in the outer peripheral wall 42 may be used for positioning of the camera main body 3.

Further, according to the embodiment described above, the tip end of the depth side 48 abuts against the claw 130 at the position A, and the outer surface 49 of the outer peripheral wall 42 abuts against the front surface 113 of the main body 110 at the position B. With this, rotation of the camera main body 3, which is in the preparation posture, about the first axis Ax1 due to the moment M1 can be regulated. As a result, the connection operation can be facilitated.

Further, according to the embodiment described above, the main wall 111 is provided with the opening 115. With this, the outer peripheral wall 42 can easily enter the space between the main body 110 and the claw 130. Further, the outer surface 49 of the outer peripheral wall 42 abuts at the two positions across the opening 115. With this, the camera main body 3 can be locked more stably to the bracket 2. As a result, the connection operation can be facilitated.

Further, according to the embodiment described above, the pair of vertical sides 46 and 47 are arranged at the position that allows the pair of vertical sides 46 and 47 to abut against the protruding portion 120 when the locking member 10 enters the cutout 45. With this, the camera main body 3 can be locked to the locking member 10 against the moment M2. With this, the camera main body 3 in the preparation posture can be locked more stably to the bracket 2. As a result, the connection operation can be facilitated.

Further, according to the embodiment described above, the inclination surface 134 is provided at the tip end of the claw 130. With this, the depth side 48 can smoothly enter the space between the main body 110 and the claw 130. As a result, assembly of the surveillance camera 1 is further facilitated.

Further, according to the embodiment described above, when the camera main body 3 is in the imaging posture, the locking member 10 closes the cutout 45. With this, entry of dust, insects, water droplets, and the like between the bracket 2 and the base portion 4 can be prevented. With this, the surveillance camera 1 can be operated outdoors for a long time period. However, before the camera main body 3 is in the imaging posture, the locking member 10 may be removed. Further, the cable 43 may extend from the cutout 45 being opened.

Moreover, according to the embodiment described above, one operator can easily assemble the surveillance camera 1 by using the locking member 10.

Although various embodiments are described above with reference to the drawings, it goes without saying that the present disclosure is not limited to such examples. A person skilled in the art can conceive of various changes, modifications, substitutions, additions, deletions, and equivalents within the scope described in the claims, and it should be understood that these also naturally fall within the technical scope of the present disclosure. Further, the components in the various embodiments described above may be combined as desired to an extent that does not depart from the scope of the invention.

### REFERENCE SIGNS LIST

1 Surveillance camera
2 Bracket
3 Camera main body
4 Base portion
5 Arm
6 Imaging unit
7 Shade
8 Wire
10 Locking member
21 Attachment surface
22 First facing surface
23 Locking portion
24, 42 Outer peripheral wall
25, 43 Cable
41 Second facing surface
44 Attachment portion
45 Cutout
46, 47 Vertical side
48 Depth side
49 Outer surface
110 Main body
111 Main wall
112 Side wall
113 Front surface
114 Bolt hole
115 Opening
116 Slit
117 Lower surface
120 Protruding portion
120a Side surface
121 Reinforcement rib
130 Claw
131 Intermediate point
132 Base end portion
133 Tip end portion
134 Inclination surface
135 Stress alleviation portion
Ax1 First axis
Ax2 Second axis
G Gravity center position
L1, L2 Rotation axis
M1, M2 Moment
W Wall

1. An imaging device comprising:
a bracket having an attachment surface to be attached on a wall and a first facing surface on a side opposite to the attachment surface;
an imaging unit configured to capture an image of surroundings; and
a camera main body having a second facing surface provided at a position outside an imaging range of the imaging unit, wherein
the camera main body is configured to switch postures including:
an imaging posture in which the camera main body is fixed to the bracket with the first facing surface and the second facing surface facing each other to allow the imaging unit to capture an image; and
a preparation posture in which the camera main body is temporarily fixed to the bracket with each of the first facing surface and the second facing surface being exposed, and
the camera main body in the preparation posture is temporarily fixed to the bracket by:
a wire coupling the first facing surface and the second facing surface to each other; and
a locking member being attached to the first facing surface and locking an outer peripheral wall surrounding the second facing surface so that rotation of the camera main body about a first axis parallel to and horizontal with the wall is regulated.

2. The imaging device according to claim 1, wherein
the second facing surface is provided with an attachment portion for attaching one end of the wire to a position closer to the bracket with respect to a gravity center position of the camera main body when the camera main body is in the preparation posture.

3. The imaging device according to claim 1, wherein
a cutout is formed in a part of a tip end of the outer peripheral wall in a circumferential direction, the cutout being defined by a pair of vertical sides spaced apart from each other in the circumferential direction and a depth side connecting the pair of vertical sides to each other, and
the locking member enters the cutout and abuts against the depth side to regulate rotation of the camera main body, which is in the preparation posture, about the first axis.

4. The imaging device according to claim 3, wherein
the locking member includes:
a main body to be attached to the first facing surface;
a protruding portion protruding from a front surface of the main body; and
a claw being arranged at a predetermined interval from the front surface of the main body and extending downward from a tip end of the protruding portion along the front surface of the main body in a state of being fixed to the bracket attached on the wall, and
the camera main body in the preparation posture is locked to the locking member when the depth side is arranged between the main body and the claw.

5. The imaging device according to claim 4, wherein
the camera main body in the preparation posture is locked to the locking member when the depth side abuts against the claw and an outer surface of the outer peripheral wall abuts against the main body.

6. The imaging device according to claim 5, wherein
in the main body, an opening is formed at a position facing the claw, and
an outer surface of the outer peripheral wall is configured to enter the opening, the outer surface having an arc-like shape.

7. The imaging device according to claim 4, wherein
a pair of the vertical sides abuts against the protruding portion to regulate rotation of the camera main body, which is in the preparation posture, about a second axis orthogonal to the wall.

8. The imaging device according to claim 4, wherein
a surface of the claw facing the main body is inclined toward a tip end in a direction away from the main body.

9. The imaging device according to claim 3, wherein
the locking member closes the cutout when the camera main body is in the imaging posture.

10. An attachment method, in an assembly method for assembling the imaging device according to claim 1, comprising:
an attachment step of attaching the bracket to the wall;
a temporal fixation step of setting the camera main body in the preparation posture by coupling the first facing surface and the second facing surface to each other by the wire and locking the outer peripheral wall by the locking member;
a connection step of electrically connecting the bracket and the camera main body to each other; and
a fixation step of setting the camera main body in the imaging posture by fixing the camera main body to the bracket with the first facing surface and the second facing surface facing each other.
